(19) United States
(12) Patent Application Publication
(10) Pub. No.: US 2008/0071018 A1
(43) Pub. Date: Mar. 20, 2008

(54) Toughened Poly(hydroxyalkanoic acid) Compositions

(75) Inventors: Benjamin Andrew Smillie, Kingston (CA); Julius Uradnisheck, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 11/857,799

(22) Filed: Sep. 19, 2007

Related U.S. Application Data
(60) Provisional application No. 60/845,695, filed on Sep. 19, 2006.

(51) Int. Cl. C08L 31/04; C08K 3/08; C08K 3/22; C08K 3/36

(52) U.S. Cl. 524/437; 524/441; 524/556; 525/190

(57) ABSTRACT

Disclosed is a toughened poly(hydroxyalkanoic acid) composition comprising poly(hydroxyalkanoic acid) and an impact modifier comprising an ethylene/vinyl acetate copolymer. Also disclosed are packaging materials and packaged products comprising the composition.

The application claims priority to U.S. provisional application 60/845,695, filed Sep. 19, 2006, the entire disclosure of which is incorporated herein by reference.

The invention relates to toughened poly(hydroxyalkanoic acid) composition and to product therewith.

### BACKGROUND OF THE INVENTION

Poly(hydroxyalkanoic acid) (PHA) polymers such as poly(lactic acid) (PLA) can be polymerized from renewable sources rather than petroleum and are compostable. They have a broad range of industrial and biomedical applications as films. For example, JP patent application H9-316310 discloses a poly(lactic acid) resin composition comprising PLA and modified olefin compounds. Examples of those modified olefin compounds are ethylene-glycidyl methacrylate copolymers grafted with polystyrene, poly(dimethyl methacrylate), etc., and copolymers of ethylene and alpha-olefins grafted with maleic anhydride and maleimide. Toughened PHA compositions are also disclosed in, for example, US patent application 2005/0131120; U.S. Pat. Nos. 5,883,199, 6,323,308, 6,417,294, 6,713,175, 6,756,331, 6,960,374, and 7,078,368; and EP0980894 A1.

However, physical limitations such as brittleness prevent easy sheet casting and subsequent trimming of the sheet into thermoformed articles. In addition to the difficulties of managing the brittle sheet through the sheet making process, articles subsequently thermoformed from the sheet may lack sufficient toughness for many applications. Some toughened PHA compositions have undesirably poor clarity. Accordingly, it is desirable to obtain a toughened composition to be easily melt-processed into a variety of articles with good toughness, preferably while maintaining acceptable clarity.

### SUMMARY OF THE INVENTION

The invention provides a toughened poly(hydroxyalkanoic acid) composition comprising or prepared from a poly(hydroxyalkanoic acid) and an ethylene/vinyl acetate copolymer wherein the poly(hydroxyalkanoic acid) is present in the composition from about 90 to about 99.8% and the ethylene/vinyl acetate copolymer is present in the composition from about 0.2 to about 10%; preferably the vinyl acetate is at least 29 weight % of the ethylene/vinyl acetate copolymer; and the % of PHA and the copolymer is based on the total weight of the toughened composition.

This invention also provides packaging materials or containers comprising the toughened composition.

### DETAILED DESCRIPTION OF THE INVENTION

Copolymer means polymers containing two or more different comonomers including dipolymer and terpolymer, polymers containing only two and three different comonomers respectively.

Compostable polymers are those that are degradable under composting conditions. They break down under the action of organisms (annelids) and microorganisms (bacteria, fungi, algae), achieve total mineralization (conversion into carbon dioxide, methane, water, inorganic compounds or biomass under aerobic conditions) at a high rate and are compatible with the composting process.

Biodegradable polymers are those that are capable of undergoing decomposition into carbon dioxide, methane, water, inorganic compounds or biomass in which the predominant mechanism is the enzymatic action of microorganisms that can be measured by standardized tests, in a specified time, reflecting available disposal conditions.

Renewable polymers are those that comprise or are prepared from raw or starting materials that are or can be replenished sooner than within a few years (unlike petroleum which requires thousands or millions of years), such as by fermentation and other processes that convert biological materials into feedstock or into the final renewable polymer.

Poly(hydroxyalkanoic acid) polymers are usually biodegradable or compostable polymers. A number of these are also available from processing renewable resources, such as production by bacterial fermentation processes or isolated from plant matter that include corn, sweet potatoes, and the like.

PHA compositions include polymers prepared from polymerization of a hydroxyalkanoic acid having from 2 to 7 (or more) carbon atoms, including the polymer comprising 6-hydroxyhexanoic acid, also known as polycaprolactone (PCL), and polymers comprising 3-hydroxyhexanoic acid, 4-hydroxyhexanoic acid and 3-hydroxyheptanoic acid. Of note are poly(hydroxyalkanoic acid) polymers comprising hydroxyalkanoic acids having five or fewer carbon atoms, for example, polymers comprising glycolic acid, lactic acid, 3-hydroxypropionate, 2-hydroxybutyrate, 3-hydroxybutyrate, 4-hydroxybutyrate, 3-hydroxyvalerate, 4-hydroxyvalerate and 5-hydroxyvalerate. Notable polymers include poly(glycolic acid) (PGA), poly(lactic acid) (PLA) and poly(hydroxybutyrate) (PHB). PHA compositions also include blends of two or more PHA polymers, such as a blend of PHB and PCL.

Polyhydroxyalkanoic acids can be produced by bulk polymerization. A PHA may be synthesized through the dehydration-polycondensation of the hydroxyalkanoic acid. A PHA may also be synthesized through the dealcoholization-polycondensation of an alkyl ester of hydroxyalkanoic acid or by ring-opening polymerization of a cyclic derivative such as the corresponding lactone or cyclic dimeric ester. The bulk polymerization is usually carried out using either a continuous process or a batch process. Japanese Patent application 03-502115A discloses a process wherein bulk polymerization for cyclic esters is carried out in a twin-screw extruder. JP07-26001A discloses a process for the polymerization for biodegradable polymers, wherein a bimolecular cyclic ester of hydroxycarboxylic acid and one or more lactones are continuously fed to a continuous reaction apparatus having a static mixer for ring-opening polymerization. JP07-53684A discloses a process for the continuous polymerization for aliphatic polyesters, wherein a cyclic dimer of hydroxycarboxylic acid is fed together with a catalyst to an initial polymerization step, and then continuously fed to a subsequent polymerization step built up of a multiple screw kneader. U.S. Pat. Nos. 2,668,162 and 3,297,033 disclose batch processes.

PHA polymers also include copolymers comprising more than one hydroxyalkanoic acid, such as polyhydroxy-butyrate-valerate (PHB/V) copolymers and copolymers of glycolic acid and lactic acid (PGA/LA). Copolymers can be prepared by catalyzed copolymerization of a hydroxyalkanoic acid or derivative with one or more cyclic esters and/or dimeric cyclic esters. Such comonomers include glycolide (1,4-dioxane-2,5-dione), the dimeric cyclic ester of glycolic acid; lactide (3,6-dimethyl-1,4-dioxane-2,5-dione); α,α-dimethyl-β-propiolactone, the cyclic ester of 2,2-dimethyl-3-hydroxypropanoic acid; β-butyrolactone, the cyclic ester of 3-hydroxybutyric acid; 6-valerolactone, the cyclic ester of 5-hydroxy-pentanoic acid; ε-caprolactone, the cyclic ester of 6-hydroxyhexanoic acid, and the lactones of its methyl substituted derivatives such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc.; the cyclic ester of 12-hydroxydodecanoic acid; 2-p-dioxanone; and the cyclic ester of 2-(2-hydroxyethyl)-glycolic acid.

PHA compositions also include copolymers of one or more hydroxyalkanoic acid monomers or derivatives with other comonomers, including aliphatic and aromatic diacid and diol monomers such as succinic acid, adipic acid, and terephthalic acid and ethylene glycol, 1,3-propanediol, and 1,4-butanediol. Around 100 different monomers have been incorporated into PHA copolymers.

PHA polymers and copolymers may also be made by living organisms or isolated from plant matter. Numerous microorganisms have the ability to accumulate intracellular reserves of PHA polymers. For example, PHBN has been produced by fermentation of the bacterium Ralstonia eutropha. Fermentation and recovery processes for other PHA types have also been developed using a range of bacteria including Azotobacter, Alcaligenes latus, Comamonas testosterone and genetically engineered E. coli and Klebsiella. U.S. Pat. No. 6,323,010 discloses a number of PHA copolymers prepared from genetically modified organisms.

“Poly(hydroxyalkanoic acid)” refers to a polymer or composition comprising any homopolymer or copolymer comprising a hydroxyalkanoic acid and mixtures thereof, such as those homopolymers, copolymers and blends listed above. Likewise, when a specific hydroxyalkanoic acid is used in such a term, such as poly(glycolic acid), poly(lactic acid) or poly(hydroxybutyrate), the term includes homopolymers, copolymers or blends comprising the hydroxyalkanoic acid used in the term.

Glycolic acid is derived from sugar cane. Poly(glycolic acid) can be synthesized by the ring-opening polymerization of glycolide and is sometimes referred to as poly-glycolide.

PLA includes poly(lactic acid) homopolymers and copolymers of lactic acid and other monomers containing at least 50 mole % of repeat units derived from lactic acid or its derivatives and mixtures thereof having a number average molecular weight of 3,000 to 1,000,000, 10,000 to 700,000, or 20,000 to 600,000. PLA may contain at least 70 mole % of repeat units derived from (e.g. made by) lactic acid or its derivatives. The poly(lactic acid) homopolymers and copolymers can be derived from d-lactic acid, l-lactic acid, or a mixture thereof. A mixture of two or more poly(lactic acid) polymers can be used. PLA may be prepared by the catalyzed ring-opening polymerization of the dimeric cyclic ester of lactic acid, which is referred to as “lactide.” As a result, PLA is also referred to as “polylactide.”

Copolymers of lactic acid are typically prepared by catalyzed copolymerization of lactic acid, lactide or another lactic acid derivative with one or more cyclic esters and/or dimeric cyclic esters as described above.

The composition may comprise PHA in an amount ranging from a lower limit of about 90 or 92 weight % to an upper limit of about 97, 99, 99.5, or 99.8 weight %, based on the total amount of PHA and impact modifier used.

The composition comprises at least one ethylene/vinyl acetate (EVA) copolymer as an impact modifier or toughener. It can be present in the composition in an amount ranging from a lower limit of about 0.2, 0.5, 1 or 3 weight % to an upper limit of about 8 or 10 weight %. EVA includes copolymers comprising repeat units derived from ethylene, vinyl acetate, and an additional comonomer other than a glycidyl acrylate. Of note are compositions consisting essentially of PHA and an EVA dipolymer.

EVA preferably has a particle size in the range of from about 0.01 to about 20, 0.1 to about 15, 0.2 to about 10, 0.5 to about 5, or 0.5 to 2.5 μm.

The relative amount of the vinyl acetate comonomer incorporated into EVA copolymers can vary from a few weight percent up to as high as 80 weight % of the total copolymer or even higher such as from 2 to 80, 6 to 29, or at least 30 (e.g., 30 to 45% or 30 to 80) weight %. There are EVA copolymers where the vinyl acetate content is from 46 to 80% (e.g., copolymer sold by LANXESS Corporation 111 RIDC Park West Drive, Pittsburgh, Pa. 15275-1112/USA under the Levapren®). EVA copolymer may optionally be modified by methods well known in the art, including modification with an unsaturated carboxylic acid or its derivatives, such as maleic anhydride or maleic acid. The EVA copolymer preferably has a melt flow rate or melt index (MI), measured in accordance with ASTM D-1238, of from 0.1 to 60, 0.5 to 30, 1 to 20, 1 to 15, or 1 to 10 g/10 min.

A mixture of two or more different EVA copolymers can be used in the toughened compositions where the average values for the comonomer content is within the ranges indicated above to obtain certain particularly useful properties.

To provide a toughened PHA composition that retains good transparency, the EVA impact modifier may have a refractive index (RI) that matches well with the refractive index of the PHA. For example, transparent PLA has RI of 1.46, so the impact modifier may have RI not greater than 1.5. To provide toughness and transparency, the vinyl acetate content is at least 29 weight %.

The toughened PHA composition can further comprise optional additives including plasticizers, stabilizers, antioxidants, ultraviolet ray absorbers, hydrolytic stabilizers, anti-static agents, dyes or pigments, fillers, fire-retardants, lubricants, reinforcing agents such as glass fiber and flakes, processing aids, antiblock agents, release agents, or combinations of two or more thereof.

These additives may be present in the compositions in quantities up to about 40% of the composition, or 0.01 to 15%, 0.01 to 10%, or 0.01 to weight %, of the total composition. For example, the compositions may contain from about 0.5 to about 5 weight % plasticizer; about 0.1 to about 5 weight % antioxidants and stabilizers; about 3 to about 40 weight % fillers; about 5 to about 40 weight % reinforcing agents; about 0.5 to about weight % nanocomposite reinforcing agents; and/or about 1 to about 40 weight % flame retardants. Examples of suitable fillers include glass fibers and minerals such as precipitated CaCO₃, talc, wollastonite, or combinations of two or more thereof. Fillers and reinforcing agents, when used, can be of small size. For example, a film may be less than 50 μm in thickness and accordingly, a solid additive desirably has sizes less than that. Fillers and reinforcing agents may reduce transparency of the film when present.

The composition can be prepared by melt-blending the PLA and the impact modifier and, optionally, other materials (e.g., additives) until they are homogeneously dispersed to the naked eye and do not delaminate upon film formation. The blend may be obtained by combining the component materials using any melt-mixing method known in the art. For example: 1) the component materials may be mixed to homogeneity using a melt-mixer such as a single or twin-screw extruder, blender, kneader, Banbury mixer, roll mixer, etc. to give a resin composition; or 2) a portion of the component materials can be mixed in a melt-mixer, and the rest of the component materials subsequently added and further melt-mixed until homogeneous.

The compositions may be formed into cast films or sheets by extrusion through a slit die and calendering the resultant flat sheet. Film and sheet are used to describe generally planar articles having one relatively small dimension and two relatively large dimensions. Sheets are considered to be thicker than films, but as used herein, either term is used interchangeably to describe a film and/or a sheet, without limitation to any specific thickness. For example, but not limitation, the sheets are useful to prepare packaging material and packages.

The sheets may comprise a single layer of the toughened PHA composition (a monolayer sheet). Alternatively, multilayer films or sheets comprise a layer of the toughened PHA composition and at least one additional layer comprising a different material.

Any film-grade polymeric resin or material known in the art of packaging can be employed to prepare additional layers in a multilayer structure. In many cases, the multilayer polymeric sheet may involve at least three categorical layers including, but not limited to, an outermost structural or abuse layer, an inner or interior barrier layer, and an innermost layer making contact with and compatible with the intended contents of the package and capable of forming any needed seals. Other layers may also be present to serve as adhesive layers to help bond these layers together.

The outermost structural or abuse layer may be prepared from the toughened PHA composition. Additional structure layers may include oriented polyester or oriented polypropylene, but can also include oriented polyamide (nylon). This outer layer may be unaffected by the sealing temperatures used to make a package, since the package is sealed through the entire thickness of the multilayer structure. This layer optionally may have a seal initiation temperature such that it allows for tacking down a flap or lap seal. The thickness of this layer can be selected to control the stiffness of the packaging film, and may range from about 10 to about 60 μm, or about 50 μm. The structure layer can be printed, for example, by reverse printing using rotogravure methods.

The inner layer can include one or more barrier layers to reduce the permeation rate through the layer by agents such as water, oxygen, carbon dioxide, electromagnetic radiation such as ultraviolet radiation, and methanol that potentially can affect the product inside the pouch. Such barrier layers can be applied by various methods such as solvent or aqueous coating, vacuum deposition, chemical vapor deposition, coextrusion, extrusion coating, or combinations of two or more thereof.

Barrier layers can comprise, for example, metallized polypropylene or polyethylene teraphthalate, ethylene vinyl alcohol, polyvinyl alcohol, polyvinylidene chloride, aluminum foil, silicon oxides (SiOx), aluminum oxide, aromatic nylon, blends or composites of the same as well as related copolymers thereof. Barrier layer thickness may depend on the sensitivity of the product and the desired shelf life.

The structure and barrier layers can be combined to comprise several layers of polymers that provide effective barriers to moisture and oxygen and bulk mechanical properties suitable for processing and/or packaging the product, such as clarity, toughness and puncture-resistance.

The innermost layer of the package is the sealant. The sealant is selected to have minimum effect on taste or color of the contents, to be unaffected by the product, and to withstand sealing conditions (such as liquid droplets, grease, dust, or the like). The sealant can be a polymeric layer or coating that can be bonded to itself (sealed) at temperatures substantially below the melting temperature of the outermost layer so that the outermost layer's appearance will not be affected by the sealing process and will not stick to the jaws of the sealing bar. Typical sealants used in multilayer packaging films useful in this invention include ethylene polymers, such as low density polyethylene, linear low density polyethylene, metallocene polyethylene, EVA, copolymers of ethylene and methyl acrylate or (meth)acrylic acid, or ionomers of copolymers of ethylene and (meth)acrylic acid. Sealants can also include polyvinylidene chloride, polyester copolymers, or polypropylene copolymers. Sealants can be made peelable by, for example, combinations of polymers, tackifiers and fillers. Peelable sealants are available from E. I. du Pont de Nemours and Company (DuPont), Wilmington, Del. Sealant layers are typically from about 25 to about 100 μm thick.

Polyamides (nylon) suitable for use include aliphatic polyamides, amorphous polyamides, or a mixture thereof. “Aliphatic polyamides” as the term is used herein can refer to aliphatic polyamides, aliphatic copolyamides, and blends or mixtures of these. Preferred aliphatic polyamides for use in the invention are polyamide 6, polyamide 6.66, blends and mixtures thereof. Polyamides 6.66 are commercially available from BASF AG. The film may further comprise other polyamides such as those described in U.S. Pat. Nos. 5,408,000; 4,174,358; 3,393,210; 2,512,606; 2,312,966 and 2,241,322.

The sheet may also comprise partially aromatic polyamides. Some suitable partially aromatic copolyamides are the amorphous nylon resins 6-1/6-T commercially available from DuPont for example.

Polyolefins suitable for use are selected from polypropylene or polyethylene homopolymers and copolymers comprising ethylene or propylene. Polyethylenes can be prepared by a variety of methods, including well-known Ziegler-Natta catalyst polymerization (see for example U.S. Pat. Nos. 3,645,992 and 4,076,698 and), metallocene catalyst polymerization (see e.g., U.S. Pat. Nos. 5,198,401 and 5,405,922) and by free radical polymerization. Polypropylene polymers include propylene homopolymers, impact modified polypropylene and copolymers of propylene and alpha-olefins. Because polyolefins are so well known, the description of which is omitted for the interest of brevity.

The film can comprise layers comprising ethylene copolymers such as ethylene vinyl acetate and ethylene methyl acrylate and ethylene (meth)acrylic acid polymers.

Anhydride or acid-modified ethylene and propylene homo- and co-polymers can be used as extrudable adhesive layers (also known as “tie” layers) to improve bonding of layers of polymers together when the polymers do not adhere well to each other, thus improving the layer-to-layer adhesion in a multilayer structure. The compositions of the tie layers may be determined according to the compositions of the adjoining layers that need to be bonded in a multilayer structure. One skilled in the polymer art can select the appropriate tie layer based on the other materials used in the structure. Various coextrudable tie layer compositions are commercially available from DuPont, for example. Other tie layers include solvent-applied polyurethane compositions.

Polyethylene vinyl alcohol having from about 20 to about 50 mole % ethylene can be suitable for use herein. Suitable polyethylene vinyl alcohol polymers are commercially available from Kuraray or from Nippon Gohsei, for example.

Polyvinylidene chloride can be obtained commercially from Dow Chemical, for example.

Surface modifiers such as polyglycerol esters for antifogging properties, surface radicalization such as from corona or flame treatment for improved adhesion and printability, silica microspheres or silicones for reduced coefficient of friction, long-chain aliphatic amines for antistatic properties, and primers for improved ink adhesion can also be used in the sheets.

A multilayer film or sheet can be prepared by coextrusion as follows: granulates of the various components are melted in separate extruders. The molten polymers are passed through a mixing block that joins the separate polymer melt streams into one melt stream containing multiple layers of the various components. The melt stream flows into a die or set of dies to form layers of molten polymers that are processed as a multilayer flow. The stream of layered molten polymers is cooled rapidly on a quench drum to form a layered structure.

A film or sheet can also be made by (co)extrusion followed by lamination onto one or more other layers. Other suitable converting techniques are, for example, blown film (co)extrusion and (co)extrusion coating.

Of note is a film or sheet comprising a layer of the toughened PHA composition and a heat seal layer.

The sheet may also be laminated to a substrate such as foil, paper or nonwoven fibrous material to provide a packaging material. Lamination involves laying down a molten curtain of an adhesive composition between the substrate and the PHA film moving at high speeds (about 30 to 300 m/minute or about 90 to 240 m/minute) as they come into contact with a cold (chill) roll. The melt curtain is formed by extruding the adhesive composition through a flat die. Solution-based adhesive compositions may also be used to adhere the film to the substrate.

Films and sheets can be used to prepare packaging materials such as containers, pouches and lidding, balloons, labels, tamper-evident bands, or engineering articles such as filaments, tapes and straps.

Packages and packaged products can comprise the compositions, films, and/or structures disclosed above. The packages may comprise the films wrapped around the packaged product and optionally comprising other packaging materials. Packages may also be formed of one or more portions of film bonded together, for example by heat sealing. Such packages may have the form of pouches, packets, vacuum skin packaging and the like. Pouches are formed from film web stock by cutting and heat-sealing separate pieces of web stock and/or by a combination of folding and heat-sealing with cutting. Tubular films may be formed into pouches by sealing across the tube (transverse seal). Other packages include containers with lidding films prepared from the toughened PHA compositions as described herein.

Toughened PHA compositions can also be provided in other forms, including shaped articles, molded articles, etc. The containers and packaging materials can be of various shapes including trays, cups, caps, or lids prepared from sheets by vacuum or pressure forming; shapes prepared by deep drawing an unstretched sheet (i.e. thermoforming); shapes prepared by extrusion blow molding or biaxial stretching blowing parisons (injection stretch blow molding) and the like; profile extruded articles; shapes prepared by injection molding, compression molding or other molding processes; and shapes prepared by folding a sheet and heat sealing its edges such as a gable-topped carton. Other containers comprising the toughened PHA composition may be in the form of squeezable tubes, pouches or bottles; components of containers (such as a cap, cap liner, lid, screw top, or other closure); bags or pouches within a rigid container that dispense liquids such as wine, medical fluids, baby formula; and blister packs. A packaging material in one of these forms exhibits the same toughened properties as those described for the films.

A film or sheet comprising the toughened PHA composition could be further processed into a shaped article that could be included in packaging. For example, the film or sheet could be thermoformed. Thermoformed articles may have a shape in which a sheet of material forms a concave surface such as a tray, cup, can, bucket, tub, box or bowl. The thermoformed article may also comprise a film with a cup-like depression formed therein. The thermoformed film or sheet may be shaped to match the shape of the material to be packaged therein. Flexible films when thermoformed as described retain some flexibility in the resulting shaped article. Thicker thermoformed sheets may provide semi-rigid or rigid articles. Thermoformed articles may be combined with additional elements, such as a generally planar film sealed to the thermoformed article that serves as a lid (a lidding film).

The packaging materials, such as films or sheets, may also be processed further by, for example, printing, embossing and/or coloring to provide a packaging material to provide information to the consumer about the product therein and/or to provide a pleasing appearance of the package.

Products that can be packaged include food and non-food items including beverages (e.g., carbonated beverages, orange juice, apple juice, grape juice, other fruit juices and milk), solid foods (e.g., meats, cheese, fish, poultry, nuts, coffee, applesauce or other sauces, stews, dried fruit, food paste, soups and soup concentrates and other edible items), spices, condiments (e.g., ketchup, mustard, and mayonnaise), pet food, cosmetics, personal care products (e.g., toothpaste, shaving foam, soaps, shampoos, lotions and the like), pharmaceuticals, fragrances, electronic components, industrial chemicals or household chemicals (e.g., laundry detergent, fabric softener), agrochemicals, medical devices and equipment, medicinal liquids, fuels, and biological substances.

Of note is a package comprising a thermoformed container such as a tray, cup, or bowl comprising the toughened PHA composition, and a lidding film comprising a PHA composition, including toughened PHA.

Such containers may be used to package products such as yogurts, puddings, custards, gelatins, fruit sauces (for example, applesauce), cheese spreads and dips, meats, frozen or refrigerated meals, dry foods (e.g., noodles and seasoning for reconstitution with water) or dry snacks (e.g., cookies, chips and the like).

The films may also be slit into narrow tapes and drawn further to provide slit film fibers for use as degradable sutures.

The following Examples are merely illustrative, and are not to be construed as limiting the scope of the invention described and/or claimed herein.

### Materials Used

PLA-1 was a PLA with a melting point of about 150° C. available commercially as NatureWorks® 2002DL.

EVA-1 was an ethylene/vinyl acetate dipolymer having 28 wt % of vinyl acetate and a melt index (MI; measured according to ASTM D1238; 190° C./2.16 kg) of 3 g/10 min.

EVA-2 was an ethylene/vinyl acetate dipolymer having 40 wt % of vinyl acetate (MI=52 g/10 min).

EVA-3 was an ethylene/vinyl acetate dipolymer having 40 wt % of vinyl acetate (MI=3 g/10 min).

EVA-4 was an ethylene/vinyl acetate dipolymer having 40 wt % of vinyl acetate (MI=6 g/10 min).

### COMPARATIVE EXAMPLE 1 AND EXAMPLES 2-3

Using a 25 mm 38/1 L/D ZSK-25 World Lab twin-screw extruder manufactured by Krupp Werner & Pfleiderer (W&P) melt blends of PLA-1 and the impact modifier were prepared. The compositions of the melt blends are shown below. In each case PLA-1 and impact modifier were co-fed using K-tron loss in weight feeders into the throat of the twin-screw extruder. In all cases the PLA-1 was predried overnight in a desiccant hopper with a set-point temperature of 40 to 45° C. The melt blend exiting the extruder through a two-hole die was water quenched and then the quenched strand was cut into pellets using a Scheer pelletizer. Typical extruder operating conditions for the 25 mm twin-screw extruder are shown in Table 1.

Comparative Example C1: 100% PLA-1.

Example 2: 95% PLA-1 and 5% EVA-1.

Example 3: PLA-1 and 5% EVA-2.

TABLE 1

| Example 3 | Set Point | Actual |
|---|---|---|
| Temperature Control Zone 1 (Barrel Zones 2 and 3) | 215° C. | 215° C. |
| Temperature Control Zone 2 (Barrel Zones 4 and 5) | 215° C. | 215° C. |
| Temperature Control Zone 3 (Barrel Zones 6 and 7) | 200° C. | 201° C. |
| Temperature Control Zone 4 (Barrel Zones 8 and 9) | 200° C. | 201° C. |
| Temperature Control Zone 5 (Die) | 200° C. | 200° C. |
| Screw RPM | | 205 |
| Torque % | | 75 |
| Die pressure (Mpa) | | 1.4 |
| Melt Temperature ° C. | | 212 |
| PLA-1 Feed Rate (g/min) | 285 | |
| EVA-2 Feed Rate (g/min) | 15 | |
| Vacuum (mm Hg) Zone 4 | | 29 |
| Strand Die | 2 holes | |
| | (6 mm) | |
| Scheer cutter set pt. | 20 | |

After drying overnight at 40 to 45° C. in a desiccant hopper drier, the pellets prepared were used to cast 19-cm wide amorphous sheets. The sheets were cast using a 31.75-mm diameter 30/1 L/D single screw extruder fitted with a 3/1 compression ratio, single-flight screw with 5 L/D of a melt mixing section. There was a 60/80/60 square mesh screen on the breaker plate at the end of the extruder barrel. The extruder die was a 203-mm wide coat hanger type flat film die with a 0.76 mm die gap. The extruder was built by Wayne Machine (Totowa, N.J.). The molten polymer film exiting from the die drawn down to nominally 0.8 mm thick as it was cast onto a 203-mm wide by 203-mm diameter double shell spiral baffle casting roll fitted with controlled temperature cooling water. The casting roll and die were built by Killion Extruders (Davis Standard, Cedar Grove, N.J.). Extruder conditions are provided in Table 2.

TABLE 2

| Extruder Conditions | Set point | C1 actual | 2 actual | 3 actual |
|---|---|---|---|---|
| Barrel Zone 1 ° C. | 215 | 215 | 215 | 215 |
| Barrel Zone 2 ° C. | 215 | 215 | 215 | 215 |
| Barrel Zone 3 ° C. | 215 | 216 | 214 | 215 |
| Barrel Zone 4 ° C. | 215 | 221 | 219 | 217 |
| Filter Flange ° C. | 215 | 215 | 215 | 215 |
| Adapter ° C. | 215 | 215 | 215 | 215 |
| Die End ° C. | 215 | 215 | 215 | 215 |
| Flat Die ° C. | 215 | 215 | 215 | 216 |
| Filter Melt ° C. | | 213 | 211 | 209 |
| Adp Melt ° C. | | 227 | 226 | 226 |
| Filter-Press (MPa) | | 10.3 | 9.1 | 8.8 |
| Adapter-Press (MPa) | | 5.5 | 4.9 | 5.2 |
| Screw RPM | | 100 | 100 | 99 |
| Screw Amps | | 3.4 | 3.2 | 3.0 |
| Throughput (g/min) | | 247 | 226 | Not measured |
| Cast Roll cm/min | 162 | 131 | 131 | 113 |
| Nip Pressure (MPa) | 0.7 | 0.6 | 0.6 | 0.6 |
| H₂O Recirculation | 40 | 39 | 41 | 42 |
| Unit Temperature | | | | |
| (° C.) | | | | |
| Adapter ° C. | 215 | 215 | 215 | 215 |

The cast sheet samples were used to thermoform shallow trays (depth 3 cm, length 15 cm, width 10 cm) on a model 810/1 Thermoformer made by Sencorp Systems (Hyannis Ma 02601). Thermoforming conditions for sheet samples C1 and 2 used a set-point temperature for top and bottom oven control zones of 190° C. The top and bottom oven set-point temperatures for Example 3 were 204° C. Each sheet was preheated for 45 seconds prior to forming using a 25-second vacuum dwell, 20-second platen dwell and a 5-second air eject.

Dynatup impact measurements according to ASTM D3763 on 0.5-mm thick modified PLA trays at ambient temperature (23° C.) are reported in Table 3. In the Dynatup testing a 45-kg dart was used with a 1.27-cm diameter tip. The sample was clamped into place using a 3,2-cm-diameter retaining ring. The dart was dropped from a height of 51 cm to give an initial impact velocity of 3.2 m/sec. Three replicates of Comparative Example C1 were tested. Five replicates were tested of Example 2. Four replicates were tested of Example 3. In this test method, the total energy to failure in joules is measured; higher numbers illustrate better toughening.

The trays made from 100% PLA-1 (Comparative Example C1) were so brittle that the equipment was unable to measure any measurable resistance to the dart as it penetrated the sample (negative energy values of −2.7, −2.7 and −2.8 J). The trays made from Examples 2 and 3 provided better toughness than Comparative Example C1, particularly Example 2.

TABLE 3

| | | Haze (%) | |
|---|---|---|---|
| | | 0.5 mm | |
| Example | Total Energy to Failure (joules) | tray | 0.8 mm sheet |
| C1 | 0 | 4 ± 0.4 | 6 ± 0.6 |
| 2 | 4.4 ± 1.4 | 67 ± 1.3 | 92 ± 4.3 |
| 3 | 0.16 ± .04 | 20 ± 1.2 | 46 ± 0 |

The original 0.8 mm thick cast sheet as well as the 0.5 mm thick trays were used to measure the haze (according to ASTM D1003) and the results of haze testing are also given in Table 3. Six replicates of Comparative Example C1 and of Example 2 were tested. Four replicates of Example 3 were tested.

In Table 3, the value at 0.5-mm thickness corresponded to the thermoformed tray and the value at 0.8-mm thickness corresponded to the original cast sheet. The least haze was observed with the Comparative Example C1, the unmodified PLA sheet. Example 2 had high haze. The sheet and tray made from Example 3 had lower haze than Example 2, showing the effect of higher vinyl acetate content for improving transparency of toughened PHA compositions. It is reasonable to assume that the relationship between haze and thickness (on sheet or thermoformed part) would be linear assuming no significant crystallization occurred during thermoforming, so less haze could be achieved by forming a thinner part. Less haze could also be achieved by using less of the impact modifier in the PHA composition, provided sufficient toughening was maintained. The results in Table 3 illustrate that toughened PLA provide improved toughness and in some cases provide acceptable clarity.

### COMPARATIVE EXAMPLE 2 AND EXAMPLES 4-7

Sheet samples are shown in Table 4. PLA-1 pellets were dried overnight in a desiccant hopper drier at 40 to 45 C. In this set of samples 1140 g of the dried PLA-1 polymer pellets were blended with 60 g of EVA pellets by shaking the ingredients together in bag for 30 seconds after which the bag contents were dumped into the hopper of the single screw extruder and the pellet blend was then melt extruded and blended and then shaped into 0.9 mm thick sheet.

TABLE 4

| | Example | | | | |
|---|---|---|---|---|---|
| Composition | C2 | 4 | 5 | 6 | 7 |
| PLA-1 (gm) | 1200 | 1140 | 1140 | 1140 | 1140 |
| EVA-1 (gm) | 0 | 60 | 0 | 0 | 0 |
| EVA-2 (gm) | 0 | 0 | 60 | 0 | 0 |
| EVA-3 (gm) | 0 | 0 | 0 | 60 | 0 |
| EVA-4 (gm) | 0 | 0 | 0 | 0 | 60 |

The sheets were cast as disclosed above. Extruder conditions are provided in Table 5.

TABLE 5

| Extruder Conditions | Set point | C2 | 4 | 5 | 6 | 7 |
|---|---|---|---|---|---|---|
| Barrel Zone 1 ° C. | 215 | 215 | 215 | 215 | 215 | 215 |
| Barrel Zone 2 ° C. | 215 | 215 | 215 | 215 | 215 | 215 |
| Barrel Zone 3 ° C. | 215 | 215 | 215 | 215 | 215 | 215 |
| Barrel Zone 4 ° C. | 215 | 215 | 215 | 215 | 215 | 215 |
| Filter Flange ° C. | 215 | 215 | 215 | 215 | 215 | 215 |
| Adapter ° C. | 215 | 215 | 215 | 215 | 215 | 215 |
| Die End ° C. | 215 | 215 | 215 | 215 | 215 | 215 |
| Filter Melt ° C. | | 209 | 210 | 209 | 209 | 210 |
| Adp Melt ° C. | | 229 | 228 | 227 | 228 | 228 |
| Filter-Press (MPa) | | 11.2 | 11 | 10.6 | 10.6 | 10.3 |
| Adapter-Press (MPa) | | 5.9 | 6.1 | 5.9 | 6.2 | 6.1 |
| Screw RPM | | 100 | 100 | 100 | 100 | 100 |
| Screw Amps | | 3.2 | 3.1 | 3.1 | 3.1 | 3.2 |
| Cast Roll cm/min | | 131 | 125 | 125 | 125 | 125 |
| Nip Pressure (MPa) | 0.6 | NR | NR | NR | NR | NR |
| H₂O Recirculation | | NR | 40 | 40 | 35 | 40 |
| Unit Temperature(° C.) | | | | | | |

The cast sheet samples were used to thermoform shallow trays as disclosed above except that the thermoforming conditions for sheet samples C2 and 4-7 used a set-point temperature for top and bottom oven control zones of 176° C.

Dynatup impact measurements were carried out the same as disclosed above except that the average and standard deviation were based on testing of four replicates.

The trays made from 100% PLA-1 (Comparative Example C2) and 95% PLA-1 and 5 wt % EVA-2 were so brittle that the equipment was unable to measure any measurable resistance to the dart as it penetrated the sample. The trays made from Examples 4 and 7 provided better toughness than Comparative Example C2. The trays made from example 6 (5 wt % EVA-3) had significantly improved toughness over the other example trays.

TABLE 6

| | | Haze (%) | |
|---|---|---|---|
| | | 0.7 mm | |
| Example | Total Energy to Failure (joules) | tray | 0.9 mm sheet |
| C2 | 0 | 7.5 ± 1 | 9.6, 10.0 |
| 4 | 0.43 ± 0.1 | 57 ± 2 | 87, 89 |
| 5 | 0 | 24 ± 2 | 41, 38 |
| 6 | 2.6 ± 0.9 | 29 ± 3 | 55, 56 |
| 7 | 0.61 ± 0.4 | 30 ± 6 | 56, 51 |

The original 0.9 mm thick cast sheet as well as the 0.7 mm thick trays were used to measure the haze and the results (Table 6; the average and standard deviation on four replicate haze measurements for the tray and the two measures for the sheet). In Table 6, the value at 0.7 mm thickness corresponded to the thermoformed tray and the value at 0.9 mm thickness corresponded to the original cast sheet. The least haze was observed with the Comparative Example C2, the unmodified PLA sheet. Example 4 which contained 5 wt % of EVA-1 had high haze. The sheet and tray made from Examples 5, 6 and 7 had lower haze than Example 4, showing the effect of higher vinyl acetate content for improving transparency of toughened PHA compositions. It is reasonable to assume that the relationship between haze and thickness (on sheet or thermoformed part) would be linear assuming no significant crystallization occurred during thermoforming, so less haze could be achieved by forming a thinner part. Less haze could also be achieved by using less of the impact modifier in the PHA composition, provided sufficient toughening was maintained. The results in Table 5 illustrate that the addition of 5 wt % of an EVA with at least a 3MI and preferably at least 40 wt % vinyl acetate comonomer to PLA can provide improved toughness and in some cases provide acceptable clarity.

1. A composition comprising, or produced from, about 90 to about 99.8 weight % of a poly(hydroxyalkanoic acid) composition and about 0.2 to about 10 weight % of an ethylene/vinyl acetate copolymer, based on the total weight of the poly(hydroxyalkanoic acid) and the copolymer.

2. The composition of claim 1 wherein the poly(hydroxyalkanoic acid) comprises repeat units derived from 6-hydroxyhexanoic acid, 3-hydroxyhexanoic acid, 4-hydroxyhexanoic acid, 3-hydroxyheptanoic acid, or combinations of two or more thereof.

3. The composition of claim 1 wherein the poly(hydroxyalkanoic acid) comprises repeat units derived from hydroxyalkanoic acids having five or fewer carbon atoms.

4. The composition of claim 3 wherein the poly(hydroxyalkanoic acid) comprises repeat units derived from glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, or combinations of two or more thereof.

5. The composition of claim 4 wherein the poly(hydroxyalkanoic acid) comprises poly(glycolic acid), poly(lactic acid), poly(hydroxy-butyric acid), poly(hydroxy-butyrate-valerate) copolymer, copolymer of glycolic acid and lactic acid, hydroxyvaleric acid, 5-hydroxyvaleric acid, or combinations of two or more thereof.

6. The composition of claim 1 consisting essentially of about 90 to about 99.8 weight % of a poly(hydroxyalkanoic acid) and about 0.2 to about 10 weight % of an ethylene/vinyl acetate dipolymer.

7. The composition of claim 6 wherein the dipolymer has vinyl acetate content of from 6 to 28% by weight.

8. The composition of claim 6 wherein the dipolymer has vinyl acetate content of at least 29 weight %.

9. A packaging material comprising or produced from the composition comprising or produced about 90 to about 99.8 weight % of a poly(hydroxyalkanoic acid) composition and about 0.2 to about 10 weight % of an ethylene/vinyl acetate copolymer, based on the total weight of the poly(hydroxyalkanoic acid) and the copolymer wherein the packaging material is a film or sheet.

10. The packaging material of claim 9 wherein the poly(hydroxyalkanoic acid) comprises poly(glycolic acid), poly(lactic acid), poly(hydroxy-butyric acid), poly(hydroxy-butyrate-valerate) copolymer, copolymer of glycolic acid and lactic acid, hydroxyvaleric acid, 5-hydroxyvaleric acid, or combinations of two or more thereof.

11. The packaging material of claim 9 wherein the packaging material further comprises at least one additional layer including ethylene vinyl acetate copolymer, ethylene acid copolymer or ionomer thereof, polyvinylidene chloride, polyester, polyvinyl alcohol, ethylene vinyl alcohol copolymer, polyamide, aluminum, silicon oxides, aluminum oxides, nonwoven fibrous material, paper, or combinations of two or more thereof.

12. An article comprising a packaging material wherein the article is a shaped article or molded article; the packaging material is film or sheet as recited in claim 9 and optionally comprises at least one additional layer comprising or produced from ethylene vinyl acetate copolymer, ethylene acid copolymer or ionomer thereof, polyvinylidene chloride, polyester, polyvinyl alcohol, ethylene vinyl alcohol copolymer, polyamide, aluminum, silicon oxides, aluminum oxides, nonwoven fibrous material, paper, or combinations of two or more thereof.

13. The article of claim 12 wherein the article is a container, optionally a thermoformed container.

14. The article of claim 12 comprising a lidding film wherein the lidding film comprises, or is prepared from, about 90 to about 99.8 weight % of a poly(hydroxyalkanoic acid) composition and about 0.2 to about 10 weight % of an ethylene/vinyl acetate copolymer, based on the total weight of the poly(hydroxyalkanoic acid) and the copolymer; and the lidding film optionally comprises at least one additional layer comprising or produced from ethylene vinyl acetate copolymer, ethylene acid copolymer or ionomer thereof, polyvinylidene chloride, polyester, polyvinyl alcohol, ethylene vinyl alcohol copolymer, polyamide, aluminum, silicon oxides, aluminum oxides, nonwoven fibrous material, paper, or combinations of two or more thereof.

15. The article of claim 14 being a thermoformed container comprises a lidding film which comprises the additional layer including the dipolymer having vinyl acetate content of from 6 to 28% by weight.

16. The article of claim 15 wherein the vinyl acetate content is at least 29 weight %.

17. The article of claim 16 wherein the article is a container, optionally a thermoformed container.

18. The article of claim 13 wherein the container comprises a product including beverage, solid food, spice, condiment, pet food, cosmetic, personal care product, pharmaceutical, fragrance, electronic component, industrial chemical, household chemical, agrochemicals, medical device or equipment, medicinal liquid, fuel, or biological substance.

19. The packaged product of claim 17 wherein the package is a thermoformed container prepared from the composition.

20. The article of claim 15 wherein the container comprises a product including beverage, solid food, spice, condiment, pet food, cosmetic, personal care product, pharmaceutical, fragrance, electronic component, industrial chemical, household chemical, agrochemicals, medical device or equipment, medicinal liquid, fuel, or biological substance.
